(19) United States
(12) Patent Application Publication
(10) Pub. No.: US 2017/0140374 A1
(43) Pub. Date: May 18, 2017

(54) SYSTEMS AND METHODS FOR EXTENDING IDENTITY ATTRIBUTES AND AUTHENTICATION FACTORS IN AN ePAYMENT ADDRESS REGISTRY

(71) Applicant: Intercontinental Exchange Holdings, Inc., Atlanta, GA (US)

(72) Inventors: Richard J. O'Brien, Lisle, IL (US); Andrew Gallant, Rockville, MD (US); Franco Modigliani, Belmont, MA (US); Francis M. Vitagliano, Boston, MA (US)

(21) Appl. No.: 15/377,227

(22) Filed: Dec. 13, 2016

Related U.S. Application Data
(63) Continuation of application No. 14/882,674, filed on Oct. 14, 2015.
Application No. 14/882,674 is a continuation of application No. 13/838,187, filed on Mar. 15, 2013, now abandoned.
Application No. 13/838,187 is a continuation-in-part of application No. 12/892,187, filed on Sep. 28, 2010, now Pat. No. 8,447,630.
Application No. 12/892,187 is a continuation-in-part of application No. 11/592,510, filed on Nov. 3, 2006, now Pat. No. 7,945,511.
Application No. 11/592,510 is a continuation-in-part of application No. 10/786,023, filed on Feb. 26, 2004, now Pat. No. 7,831,490.
(60) Provisional application No. 60/733,982, filed on Nov. 3, 2005.
(60) Provisional application No. 60/450,754, filed on Feb. 28, 2003.

(51) Int. Cl. G06Q 20/38; H04L 29/06; H04L 9/30; G06Q 40/04; H04L 9/14; H04L 9/00; G06Q 20/40; G06Q 20/06; G06F 17/30; H04L 9/32

(52) U.S. Cl. CPC G06Q 20/3829; G06F 17/30864; H04L 63/083; H04L 9/30; H04L 9/3226; H04L 9/14; H04L 9/006; G06Q 20/4014; G06Q 20/065; G06Q 40/04; G06Q 20/381; H04L 2209/56; G06Q 2220/00

(57) ABSTRACT

A network of registries is synchronized in whole or in part to a root registry; and are compilations of registrant data from accredited Identity Providers that accept liability for registering verified and accurate identity attributes. Registries associate a unique identifier with: a financial account owner's Personally Identifying Information; one or more linked publicly discoverable ePayment addresses to an account at a Financial Institution and a financial account owner's profile of preferences related to the capture, handling, transfer and storage of monetary and informational assets. Preferences extensions include: operating instructions and rule sets; and authentication factors that may make use of time sensitive data at one or more institutions.

### CROSS-REFERENCE TO RELATED APPLICATIONS

This application is a continuation of U.S. application Ser. No. 14/882,674 filed on Oct. 14, 2015, which is a continuation of U.S. application Ser. No. 13/838,187, filed on Mar. 15, 2013, which is a continuation-in-part of U.S. application Ser. No. 12/892,187, filed on Sep. 28, 2010, now U.S. Pat. No. 8,447,630, issued on May 21, 2013, which is a continuation-in-part of U.S. application Ser. No. 11/592,510, filed on Nov. 3, 2006, now U.S. Pat. No. 7,945,511, issued on May 17, 2011, which claims the benefit of U.S. Provisional Application No. 60/733,982, filed on Nov. 3, 2005 and which is a continuation-in-part of U.S. application Ser. No. 10/786,023, filed on Feb. 26, 2004, now U.S. Pat. No. 7,831,490, issued on Nov. 9, 2010, which claims the benefit of U.S. Provisional Application No. 60/450,754, filed on Feb. 28, 2003, the entire contents of all of which are incorporated herein by reference.

### TECHNICAL FIELD

This disclosure relates to a system and method of making financial transactions, and more particularly, a system and method of making deposits and payments without the need for security or encryption devices. This disclosure also relates to a computer system and method to a.) establish and validate an individual's new and existing unique identity attributes related to the individual's primary identity; b.) validate physical devices when used to effect the transfer, storage and retrieval of informational and/or monetary assets; c.) maintain safeguards to ensure that custodians of informational and monetary assets execute instructions of owners; and d.) facilitate the use of additional authentication factors when effecting the transfer, storage and retrieval of informational and/or monetary assets.

### BACKGROUND

In today's fast paced computer dependent world, people make purchases, payments, deposits, and other financial transactions without the exchange of traditional money, checks, or even the simple act of handing a teller a credit or debit card. Many transactions made by individuals today are done over the telephone or Internet. Such public forums and systems require security measures, which are often tedious, inconvenient, and can cause long delays in what are otherwise simple transactions. Payments for goods and services generally require a transfer of funds by way of cash, check, money order, or credit card. While merchants and restaurants accept credit cards, most people do not. Most people making small financial transactions do not have the luxury of a personal credit card machine that can record transactions and conduct a quick credit check, thereby limiting them to accept cash or checks. Yet, with a check, there is the risk of being kited. Additionally, most individuals must make a special trip to the bank in order to make a simple deposit of cash and/or checks. A “short” trip to the bank can often waste hours.

The time delays and the expense of relatively simple transactions can be a huge inconvenience given today's harried lifestyles. Most people work regular nine-to-five jobs, the same hours as banks, with little free time during the weekday. This causes people to waste what precious time they have on the weekends. Weekends are often spent food shopping, clothes shopping, house cleaning, and maintaining and repairing house and car, not to mention meeting the obligations of family and kids. With so many errands to run, the weekend can be even more hectic than the workweek.

Therefore, there remains a need in the art for an easy and convenient system and method for making and/or receiving payments and credits, without the need for security or encryption devices.

In the face of mounting market shifts, new technologies, and regulations, financial institutions must look to new revenue sources. The growth in e-commerce, mobile commerce, and alternative providers adds urgency to that search.

Greenlist® verified ePayments are safe and secure without consumers having to disclose any actual account or bankcard information whatsoever. In order to attain scale and ubiquity, this registry resource is operated by a network of synchronized Authoritative Parties that verify identities and payment addresses before transactions are made. Data in the Greenlist® network of registries are supplied by only Financial Institutions (FIs) functioning as registrars that accept the liability for accuracy. Registrars perform identity proofing of every registrant's Personal Identifying Information (PII) prior to registering new linked identity attributes to the Greenlist® registry. A Relying Party obtains access to trusted registrant data from an Authoritative Party and may provide access for applications or individuals via its public or private portal.

FIs maintain the Greenlist by becoming accredited and therefore trusted Identity Providers who assume the risk for identity-related fraud based on the customer information they place in the registry. This approach substantially reduces the Relying Party's cost of bearing risks because they are left with only those risks associated with payer authentication and authorization--risks entirely in their own control.

Regulations such as Dodd-Frank Section 1073 require new levels of transparency and identity proofing for cross-border payment transactions. The Federal Financial Institutions Examination Council (FFIEC) further advises Financial Institutions to layer additional authentication security factors as risk increases. These regulatory pressures mirror congressional intent and are executed under the authority of the Central Bank of the U.S., namely, the Federal Reserve Banks. Sovereign states want their regulatory regime to a.) support Anti-Money Laundering best practices, b.) be aligned with the U.S. and c.) operate accordingly in harmony with the U.S.

Because of the effect of new regulations banks are now beginning to recognize their need for new methods and systems with speedy access to information pertaining to which currencies a recipient can or will accept and which foreign exchange companies are approved for use by the issuer of the recipient's financial account. Supplying this information in the most expeditious manner possible is valuable because it further enables payments across borders to be made instantly and because of the trust in the recipient's address, payments across borders can also be made without repudiation due to lack of sender authorization.

A system to determine a priori that identity attributes and authentication factors must be used and how to obtain them is the subject of this disclosure.

### SUMMARY

The present disclosure provides a system for conducting financial transactions comprising an account, residing at a financial institution, capable of accepting deposits given a publicly available Unique Identifier of the account holder. One aspect of the present disclosure provides a method of conducting a financial transaction by providing a payer with a publicly accessible Unique Identifier, directing the payer to an account, associated with the Unique Identifier, and/or financial institution where the account resides, and completing the financial transaction by depositing funds into the account.

In another aspect of the present disclosure, a payee can conduct a transaction for goods or services with a payer by giving the payer the client-recipient's Unique Identifier. The payer simply contacts a Central Directory and/or Processor and makes the transfer of funds by credit card, by mailing a check to the Central Directory/Processor (CD/P), or by authorizing the Central Directory/Processor to debit his bank account. All the information that the payer needs, is the payee's name and address, or the payee's Unique Identifier. Some examples of Unique Identifiers are name and/or address, phone number, e-mail address, ENUM registry address, etc.; it can be practically anything.

Transactions received by the Processor, via the Internet, other electronic means, mail, or even hand delivery, are screened to determine if the transaction is a debit to the payer's account or an instruction to credit (push a payment to) the payee's account. If the transaction is identified as a credit, then acceptance by the financial institution ensues and the credit is made to the payee's account. If the transaction is a debit to the payer's account, then the usual security operations are required such as encryption, PIN codes, and the like.

It is also possible for the database processors to maintain the name of linked financial institutions for each name and address, so that the payer need only know the payee's Unique Identifier. This would eliminate the need for the payer to know the payee's financial institution. Thus the payer could send a credit to the payee knowing only what is normally on a payee's business card. This would enable the payer to transmit the information for the payment or credit to the payee through the CD/P, which identifies the transaction as a credit and forwards it to the payee's bank where a Linked Credit Account resides. Since the Linked Credit Account (LCA) accepts only deposits, clients will not fear giving out their Unique Identifier. One form of unique identifier implementation of this method whereby a trusted third party payment processing network functions to mask the true bank account information is referenced in prior art of U.S. Pat. Nos. 6,317,745 and 6,173,272. However, these implementations are restricted to banks that are prior member institutions of the “trusted third party” payment network. Thus the prior art approaches do not anticipate a public directory of various forms of Linked Credit Accounts, regardless of payment form and payment network affiliation.

Some unique and valuable characteristics of the present disclosure include:
1. Using only publicly known information about the payee to accept deposits and payments, and implement fund transfers between parties.
2. Sending transaction confirmations to the payer and payee using electronic, traditional mail, courier, or the like.
3. Allowing payers to use the Internet, telephone, and other electronic-based transactions for payments knowing only the payee's name, name and address, or other Unique Identifier, and possibly the financial institution where the LCA resides.
4. Allowing payees to maintain multiple LCAs by either having different addresses, Unique Identifiers, or having LCAs at more than one financial institution.

This disclosure also relates to a computer system and method to extend an ePayment address registry to a.) establish and validate an individual's new and unique identity attributes related to the individual's primary identity; b.) validate physical devices when used to effect the transfer, storage and retrieval of informational and/or monetary assets; c.) maintain safeguards to ensure that custodians of informational and monetary assets execute instructions of owners; and d.) facilitate the use of additional authentication factors when effecting the transfer, storage and retrieval of informational and/or monetary assets.

The ePayment address registry as disclosed in previous disclosures a.) links PII public ePayment addresses to enable the immediate transfer of funds; b) enables the immediate transfer of informational assets; and c.) references instructions based on privacy preferences permitting capture, storage and disposition of certain informational assets. The intent of the aforementioned disclosures was to make ePayments safe and secure without consumers having to disclose any actual account or bankcard information whatsoever.

This disclosure extends the ePayment address registry to include identity attributes and authentication factors. This disclosure then extends the scope and usage of identity attributes and authentication factors to a broader range of informational and/or monetary asset transfer transactions.

The disclosure described herein extends the application of Greenlist ID by adding to its set of associated identity attributes and by creating a secondary Greenlist ID for some attributes that are necessary for certain other classes of machine-to-machine use cases.

For example, the case of merchant-initiated “pulls” of money commonly requires an automatic second factor that the party authorizing the “pull” is authentic. This use case utilizes a method and system of identifying and validating hardware device(s) that are certified for use to communicate the transaction authorization. Having validation of the three primary authentication factors—something you know; something you have; and something you are—minimizes multiple operational risks.

The use of additional authentication factors applies to a wide range of transaction types with common purposes that include the reduction of risk of fraud, costs and time to process.

This disclosure helps merchants by reducing systemic chargebacks associated with payments that are repudiated due to lack of proper authorization. Merchants offset their costs of interchange by reducing or eliminating their interchange fees altogether by selling valuable marketing behavioral data and analytics that are otherwise unobtainable by supply chain product and/or service suppliers. Merchants that elect to provide data for analyses of their customers' behavior will have trade advantages in the marketplace because they and their suppliers will have new awareness and capability to communicate with various customer base segments.

Payments data is now more valuable than ever before for behavioral targeting. Online advertising/data analytic companies realize premium value for data related to payments, especially data from consumers when they transact while mobile. Online advertising/data analytic companies realize opportunities for mashups by consolidating reporting and giving advertisers the ability to compare data directly as opposed to trying to process it all themselves.

For example: a customer who orders food online becomes part of a vast database that lenders might tap to help them determine whether you are a good risk. A food delivery proves that a customer actually resides at an address where the customer claims to be living. Moreover, all sorts of these data reservoirs exist, and none of them is off limits to lenders, who are coming off the worst financial debacle since the Great Depression. Risk management companies work with lenders and investors to build better underwriting mousetraps by continuously probing for ways to help clients quantify their risk to prevent fraud and otherwise insure the quality of their loans.

For example, a risk management company might peek into a customer's online-buying habits. Someone who purchases shirts from a Brooks Brothers catalog may have more disposable income than someone who shops at J.C. Penney. The safest lenders are digging into databases maintained by Domino's Pizza, Papa John's or Victoria's Secret. The only boundary is whether the information can be accessed legally. Mobile payments initiated from a smartphone can replace cash, checks and even bankcards for smaller transactions. Personal identifying information such as caller ID number and other identifiers may be used to authenticate the owner of the smartphone in order to mitigate risk that a payment is authorized. Trust that sales data obtained from authentic sources can be proven and legally certifiable will be valuable when dispute of information ownership may arise.

Accordingly, various embodiments of the present disclosure address these and other situations and issues through the existence and use of extensions to the ePayments address registry.

In one embodiment, a merchant acting as a Relying Party will query the ePayment address registry to retrieve one or more additional authentication factors for a customer engaged in a purchase transaction and/or other type of transaction. Such factors are stored in the registry when a customer (registrant) is enrolled, i.e., registered by a trusted registrar, or when a registrar or proxy registrar adds or updates the registration of an existing registrant. During the transaction, the customer supplies an identifier and public payment address. While setting up the transaction, the merchant chooses to seek additional authentication, and in one approach, the merchant will compare one or more additional authentication factors supplied by the customer with the same factors as retrieved from the registry, which is a trusted source. When these factors match, the merchant has the additional assurance that the customer is indeed authentic, and the transaction proceeds.

In another embodiment, a customer may choose to add an identity attribute related to payment and/or currency conversion instructions. Such instructions may exist in the ePayments address registry, may be stored elsewhere, or may be provided or customized during a payments or currency conversion transaction. For example, when a payments transaction involves conversion between currencies, the payment instructions may indicate the degree to which a customer receiving a payment in another currency chooses between the speed of the currency conversion and the conversion rate to be applied, e.g., whether the customer chooses between an instant payment at one rate or a delayed payment at a presumably lower rate. In this embodiment, the bank serving the customer who will receive a payment (the payee) will query the ePayments address registry for one or more identity attributes related to payments and currency conversion. While setting up the payment transaction with the payor's bank, the payee's bank will determine the applicable instructions and communicate them to the payor's bank. The payor's bank will then process the payment in accordance with those instructions.

In another embodiment, a customer (registrant) may wish to have an assured yet anonymous business arrangement, such as a paid subscription, with a merchant, content provider, or service provider, subject to applicable and appropriate laws, terms, and conditions. In this embodiment, additional identity attributes are created and stored in the ePayments address registry. Such attributes may include but are not limited to a customer identifier, possibly anonymized and/or hashed, trusted assertions about the customer, such as age or nationality, and payment information, which may include an additional ePayment address, possibly tokenized. In one example, the customer wishes to make an assured yet anonymous purchase from a merchant, in order to protect the customer's privacy. First, the customer provides an identifier and payment address. The merchant then queries the registry to validate this information. Next, the merchant may also require additional data, such as proof of age of the customer, or the customer's nationality. Then, the merchant may query the registry to receive said additional data, and may also query the registry for additional authentication factors. In this embodiment, sufficient assurance is presented to allow the merchant to fulfill the purchase, knowing both that the payment is assured and that the customer is valid; in addition, the customer is able to make the purchase yet preserve privacy and anonymity; and, both parties are assured that applicable laws, terms, and conditions have been followed.

In another embodiment, a customer's mobile or other device can be provided with one or more additional authentication factors. For example, an authentication factor for a customer can be stored both a.) either directly in the ePayments address registry or indirectly via a source pointed to from the registry, and b.) in the Secure Element of that customer's mobile device. When, for example, that device is used to make a purchase or to redeem, display, present or transfer a plane or theater ticket, the merchant can use that additional factor to validate the use of the device for the intended purpose. To do such a validation, the merchant may compare the factor retrieved from the mobile device with the relevant information provided either directly from the registry or indirectly from a source pointed to from the registry. This validation provides additional assurance that the user of the mobile device is indeed the intended customer and that the mobile device is authorized for such usage. This can be optionally be used in conjunction with or instead of a shared secret or “something known” to attain the threshold risk score that is required for the transaction to proceed. Note that communications involving one or more of bar and/or QR codes, NFC, OTA (over the air), IR, email, SMS or WiFi may be used during the above redeem, display, present and/or transfer actions above.

In another embodiment, a customer's registration records may include identity attributes related to other information or transaction addresses. In one example, a registrant may wish to include a Bitcoin address, so that this address may be retrieved during a transaction when both parties agree to use Bitcoins as the currency. In this case, the payee (the customer) provides at least the identifier registered in the ePayments address registry. The payor, who may be either trusted or may be acting through a trusted entity, receives the payee's Bitcoin payment address after the registry is queried, and may then proceed with the transfer. In other examples, other payment addresses, e.g., for bank accounts, PayPal™ accounts, etc., may be stored as identity attributes, possibly masked, hashed, or tokenized, and then retrieved for use.

In another embodiment, a customer's registration records may include other identity attributes for use in payment or information transactions. In one example, a customer's digital signature may be stored as an attribute. In another example, a pointer to a customer's digital certificate may be stored as an attribute. In this case, an entity that queries the ePayments address registry will be able to retrieve the customer's public key, which can then be, among other things, applied to materials encrypted or signed by the customer, or for encrypting materials to be used by the consumer.

In another embodiment, the payor-to-payee transaction may be subject to certain compliance requirements. In one example, the transaction will not be compliant unless certain PII-related information concerning the payor is provided to the payee during the course of the transaction. This requirement can be satisfied through the use of the ePayments address registry. First, the payor's profile is updated by a trusted registrar or proxy to contain the required information. The profile may also contain an indicator of compliance, such as of certification by a trusted third party or of a self-certification, and the profile may contain pointers to further sources of such information that may be stored external to the registry. In this example, the payor's PII-related information and possible indicator of compliance may be considered both as identity attributes (as information related to the payor) and as authentication factors (as information required by the payee), since the payee is the Relying Party.

In another embodiment, the information transaction may include the transfer or delegation of authority for one registrant to act on another registrant's behalf. For example, assume that a valid Power of Attorney is in effect, and that it grants the right for Registrant B to act on Registrant A's behalf in matters using the ePayments address registry. In this case, Registrant B could, for example, as an authorized agent of Registrant A, engage in a purchase transaction during which Registrant B can use Registrant A's payment address. To do so, each registrant's profiles would, via their respective registrars, include identity attributes that record the authorization. Further, authentication factors would be used between said registrars to ensure that Registrant A had granted sufficient authority to Registrant B to effect the latter's agency.

Device specific information, account specific information, biometric specific information and challenge specific information can be considered to be identity attributes. For example, the information included may range from specific data values (such as an individual's age) to ranges or classes of data or to summary information about this data (such as an individual being at least 21 years of age). For this disclosure, such attributes may include not only data but may also include indicators (e.g., flags) or pointers (e.g., addresses or links) related to data traditionally thought of as attributes. Below is a partial list of identity attributes included in the extended ePayments address registry in this disclosure.

Extended Types of Identity Attributes (stored, pointed to, or indicated by the registry):
PII (Personally Identifiable Information)
Demographic Information (e.g., age or age bracket)
Transaction Profile Information (e.g., additional payment address(es), payment and/or currency conversion instructions)
Other data and metadata related to the registrant's identity (e.g., additional identifier, additional profile information, pointer to digital credentials, rules)

Here, rules included as identity attributes may refer operationally to a business rules database or a transaction rules database that can follow a pre-determined path as defined by the consumer, the network, or the merchant so that, based on various operational conditions, the usage of the database can follow differing logical paths.

Also, roughly speaking, for the purposes of this disclosure, authentication factors may be considered to be data used to verify an individual's identity typically during the course of effecting the transfer, storage and retrieval of informational and/or monetary assets. In particular, such data may include the existence of operating instructions related to effecting such a transaction. Further, such authentication factors may be included directly in the extended ePayments address registry in this disclosure, may be signaled by indicators, or may be referenced indirectly. Below is a partial list of such authentication factors.

Extended Types of Authentication Factors (stored, pointed to, or indicated by the registry):
Specific information known by an individual
Biometric information for an individual
Digital credential or token of an individual
Device-specific or chip information (such as unique device or other identifiers, account information, IMEI, SIM data)
Operating instructions relevant to a transfer, storage, and/or retrieval transaction

### BRIEF DESCRIPTION OF THE DRAWINGS

To facilitate an understanding of the characteristics, structure and operation of the disclosure, preferred features of the disclosure are described in the accompanying discussion, wherein similar reference characters denote similar elements throughout the several views or embodiments, and wherein:

FIG. 1 is a graphical representation of an illustrative relationship between a Linked Credit Account and a Demand Deposit Account according to the present disclosure;

FIG. 2 is a flowchart of an illustrative method of establishing the Linked Credit Account according to the present disclosure;

FIG. 3 is a flowchart of an illustrative method of using the Central Directory Processor and Linked Credit Account according to the present disclosure;

FIG. 4 is a flowchart of an illustrative method of using the Internet's Search Engines and Domain Name System (DNS) to access and use the nearest relevant Central Directory Processor to process and accelerate a credit electronic funds transfer payment and obtain a real-time validation that payments are in irrevocable transit to a Linked Credit Account;

FIG. 5 depicts a flow diagram of the method of facilitating a cross border asset transfer transaction using extensions for preferences for payment instructions incorporated in the present disclosure; and

FIG. 6 depicts a flow diagram of the method of additional verification of a customer using extensions for authentication factors incorporated in the present disclosure.

### DETAILED DESCRIPTION

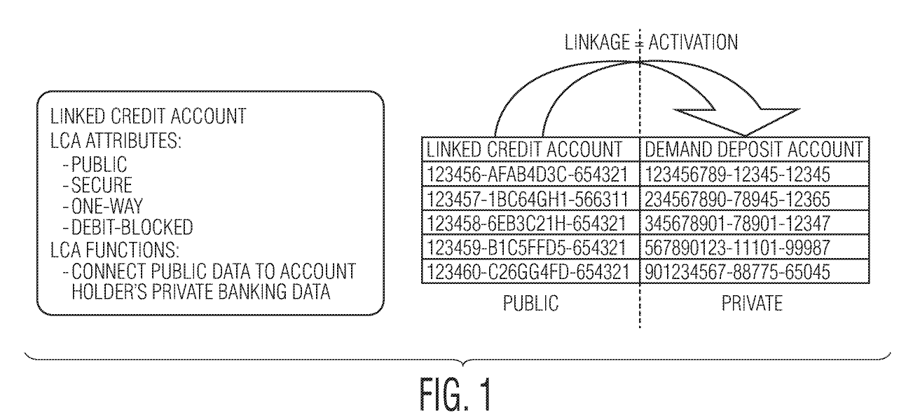

The present disclosure relates to establishing and using a linked credit account (LCA). In a preferred embodiment of the present disclosure, a central directory and/or processor is established and made public. When a payer wishes to send a payment to a payee, the payer need give only the payee's unique identifier, which the central directory/processor translates into the client's linked credit account number and/or location of the appropriate financial institution. The central directory can act essentially as the definitive root directory to all forms of LCAs. According to one embodiment, and as shown in FIG. 1, directory listings can become activated and public only after banks or other payment destination entities complete a formal enrollment process, which registers account and linkage information. The banks or other payment entities are responsible for verifying the true identity of the account holders. Conformance to enrollment rules by all banks and third party payment processing institutions insures that the linkage information is accurate and thus can be trusted by all parties.

The processor can be a bank or other third party payment processor entity. The processor may perform the enrollment function and/or payment processing functions for its clients. The processor synchronizes its sub-directory containing the activated account information of its domain with the root directory. The processor may choose in return to obtain authenticated and updated enrollment rolls from the root directory. This preferred implementation enables the central directory to synchronize LCA information to an entire network of directories which may or may not be publicly accessible. This is valuable because the neutral positioning of the central directory in the marketplace bridges the major automated clearinghouse networks by listing all forms of LCAs, without necessarily listing all forms of unique identifiers, such as other bank owned customer data. This neutrality enables adoption in the marketplace.

The processor can act as a doorway that allows funds to travel in only one direction, thereby creating a one-way account. Thus, no one other than the client can withdraw funds from the linked credit account. Additionally, the payer need never even contact the payee/client in making a deposit. Furthermore, even if the payer knows only the individual's last name and perhaps a general location, such as city of residence or employer's name, the central directory/processor may be able to identify the payee by a process of elimination.

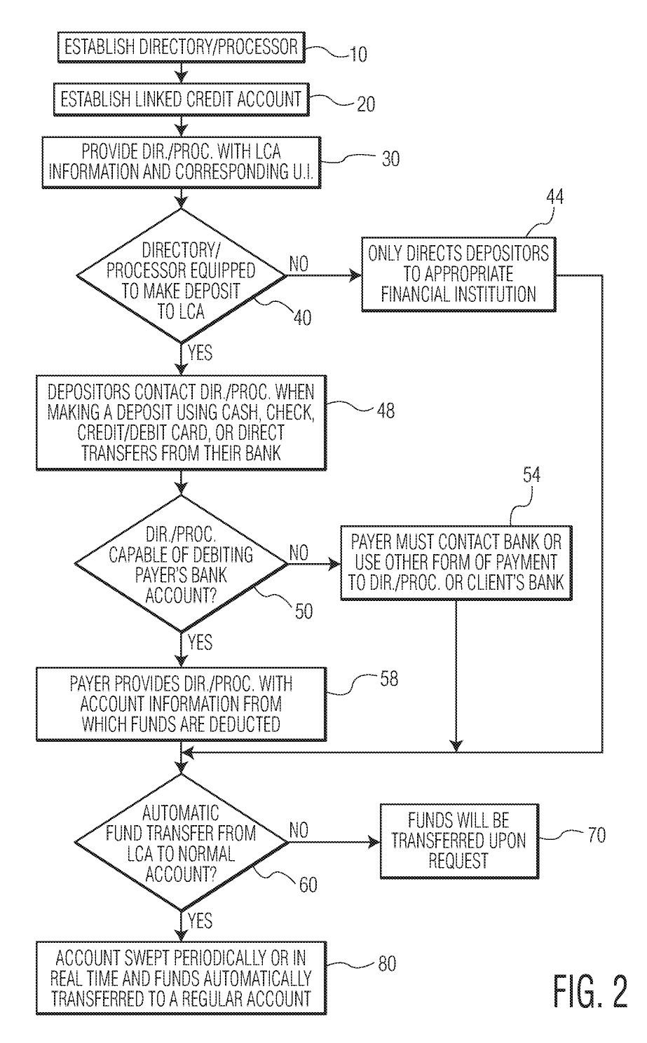

As shown in FIG. 2, a central directory/processor 10 may be established as purely a directory for routing payers to the appropriate financial institution where the linked credit account resides. As a directory, the central directory/processor can, in effect, act in the same manner as a telephone directory. However, instead of providing a payee's telephone number, the central directory/processor can provide the name and/or location of the financial institution in which the payee's linked credit account resides, and possibly the actual LCA number.

The central directory/processor may, additionally or alternatively, act as a processor of financial transactions. Specifically, the central directory/processor may be established to receive funds, in the form of cash, checks, credit card payments, and/or other known forms, and transfer the funds to the linked credit account. In this way, a payer is able to send payee(s) money while retaining total anonymity, even from the financial institution where the linked credit account resides.

The next, or simultaneous step, is establishing a linked credit account 20 with a financial institution. If desired, the central directory/processor can be set up as a financial institution. Subscribers/clients/payees can simply provide the central directory/processor with the necessary public and private information 30. For example, public information could include the client's name, nickname, title, address, etc., while private information could include the linked credit account number and location. If the central directory/processor is set up as purely a directory 44, there is no need for it to have any private information, with the exception of the name of the financial institution in which the linked credit account resides. While most people are normally reluctant to give out the name of a financial institution in which they keep accounts, this would not be the case with a linked credit account. Nevertheless, if the central directory/processor is equipped to make deposits to the appropriate linked credit account 40, the payer can simply contact the central directory/processor and transfer the desired amount using any of the aforementioned methods 48.

Additionally, the central directory/processor may even be set up to be capable of debiting a payer's bank account, when provided with the account number 58. If the central directory/processor is not set up to debit the payer's bank account 50, then the payer must either contact his/her bank to make the transaction, or use another form, such as cash, check, money order, wire transfer, credit card payment, or the like 54.

Regardless of the manner in which funds are deposited, the linked credit account may also be set up for funds to be transferred to a normal or standard type account 60. Two basic ways in which to accomplish the transfers will be described herein, however others are possible. A quick and convenient method would be to set up the linked credit account so as to provide for automatic transfers 80. These automatic transfers can be made periodically, or in real time. Naturally, it would be convenient for there to be a regular account in the same financial institution in which the linked credit account resides. However, the funds can be transferred to an account residing in another bank or even another country. An alternative would be for the transfers to be made upon request of the client of the linked credit account, or simply by mailing a check to the client's designated address.

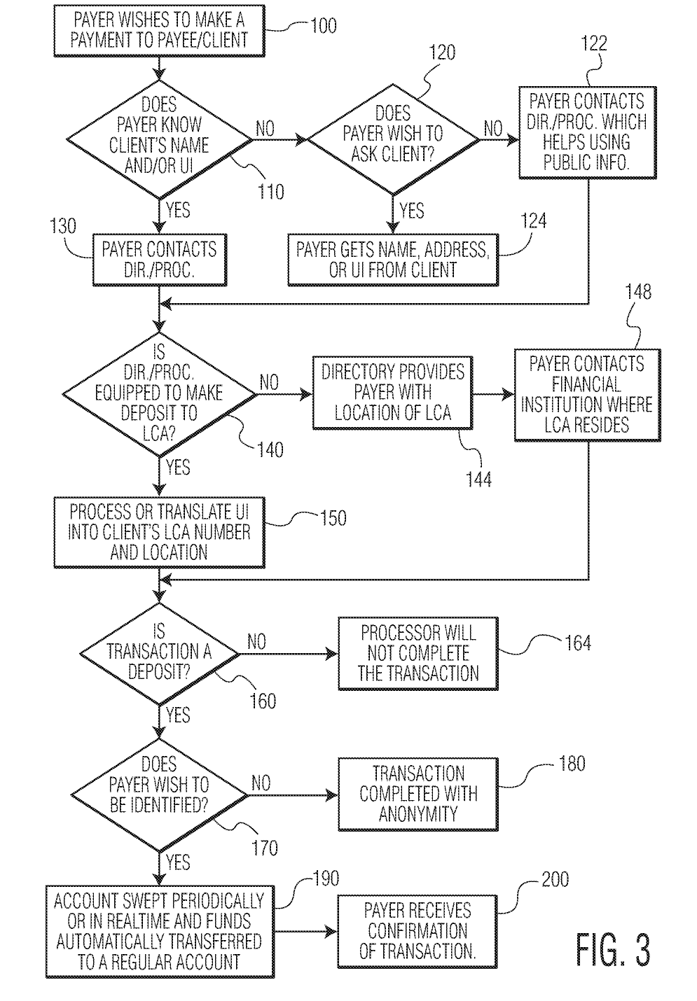

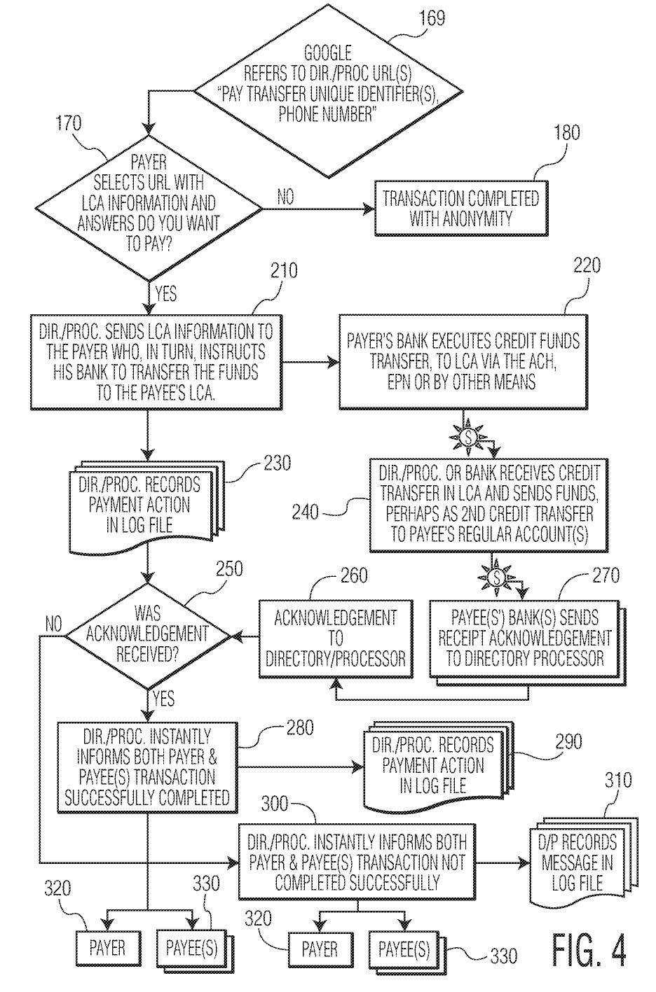

FIG. 3 shows an illustrative process for making a deposit into a linked credit account in the above-mentioned system. If a payer wishes to make a payment to a payee/client of a linked credit account 100, all that he/she needs to know is the client's unique identifier 110. The unique identifier can be anything that associates a particular linked credit account with the client, such as a nickname, address, e-mail address, license plate number, title, or the like. In this way, a client may have several linked credit accounts. Furthermore, the information necessary for associating a client with a linked credit account is preferably public information. The easier it is to locate a client's linked credit account, the easier it will be for the client to receive payments, gifts, etc. Since the linked credit account can be set up as a one-way account, there is no fear on the part of the client that someone will take funds out of it. A further discussion of the safeguards of the linked credit account will be discussed shortly. Once the payer has the unique identifier, the next step is to contact the central directory/processor.

Even if the payer does not know a client's name or unique identifier 110, the payer may still be able to locate the appropriate linked credit account and/or the financial institution where it resides. For example, if the payer knows only that the client's last name is Smith, there are several ways in which to locate the linked credit account. The easiest way would be to ask the client 124. However, if the payer wishes to remain anonymous 120, the payer can contact the central directory/processor without notifying the client 122. Even if the central directory/processor is set up only as a directory, there may be enough data associated with the linked credit account to locate it by using the process of elimination. As an example, take the name Smith, which is a very common name. Other information available to the payer may be helpful in narrowing the list down. Information such as general location (e.g., state, city, town, neighborhood), or simply the street at which the client resides or does business, may be sufficient to locate the appropriate linked credit account.

Once the payer has contacted the central directory/processor 122, 130 and the appropriate linked credit account has been located, it is time to make the deposit. If the central directory/processor is established only as a directory 140, then the central directory/processor provides the payer with the name of the financial institution where the linked credit account resides 144 and the LCA number. The payer then contacts his financial institution 148 and conducts the transfer directly. However, if the central directory/processor is established as a processor capable of depositing funds directly to the linked credit account 140, then the central directory/processor translates the unique identifier into the client's linked credit account number and location 150, and without divulging this information, conducts the transfer. In this way, it is possible to keep the location of the linked credit account anonymous, as well as the identity of the payer.

Regardless of whether the transaction is conducted through the central directory/processor or the financial institution acting as a processor, only deposits may be made by anyone other than the owner of the linked credit account. If the transaction by the payer is not a deposit 160, it will not be completed 164. However, once the transaction is recognized as a deposit, the payer may be asked whether he or she wishes to be identified 170. If the answer is no, the transaction is completed with anonymity 180. Otherwise, the transaction is initiated and completed and the owner of the linked credit account is furnished with the information provided by the payer 190. In either case, the payer and payee receive confirmations of the transaction 200 according to their respective notification preferences which are registered in the directory during the enrollment process. The confirmations can be either in the form of e-mail, letter, secure on-line pop-ups, on-line journal or transaction record entry, etc., thereby providing a dependable method of keeping track of payments. Each time a deposit is initiated and completed, the central directory/processor or the financial institution would provide a copy or e-mail of the transaction to the appropriate parties.

The central directory/processor can also be set up to aggregate transactions to determine if the net effect is a credit to the client/payee. An example might be where a client returns an item for credit and at the same time at the same merchant, purchases an item with a net effect of the two transactions resulting in credit. Thus, the central directory/processor would aggregate the two transactions and pass along both transactions possibly linking them electronically.

Another use of this disclosure would be for clients/subscribers that receive a large number of payments such as utility and telephone companies. The payer would be able to order the payment to be debited from his/her bank account, credit card account or other asset-based account and have the payment transferred or credited to the company, simply by providing the company's name or other publicly available unique identifier. The payer's financial institution would be able to do the rest. The financial institution would check the appropriate central directory/processor for the company's name and LCA number and make the transfer. The central directory/processor identifies the company's/client's transaction as a credit then matches the name, or other unique identifier, to the appropriate financial institution and linked credit account number. Once the transaction is completed, a verification of the transaction is sent to all the parties involved.

The present disclosure can allow individuals to use their usual and customary business cards or calling cards as a definitive address to receive payments. By using information about the client that is public and also identifies the client as a unique entity, the central/directory processor can process credits to the client's linked credit account without the need for any security or encryption methods. By extension, future ENUM directories are beginning to be established throughout the world to list telephone numbers as public web addresses. The present disclosure of a directory to linked credit accounts will permit web-enabled payment services to process credits to clients' linked credit accounts internationally without the need for any security or encryption methods.

This disclosure allows payers to easily switch between bill payment service providers, or easily and simultaneously use multiple bill payment service providers, such as the Internet-based bill paying service providers. The list of payees and their addresses, or other unique identifiers can be kept on the payer's computer or other database processor, and be used to obtain a validated linked credit account number from the central directory each time the payer initiates a payment. The bill payment service provider does not need to know the payee's bank account number or other receiving account. The bill payment service provider need know only the client's unique identifier and the central directory/processor of the present disclosure can link that information to the appropriate linked credit account.

Another aspect of the present disclosure is to use a client's telephone number, so that funds can be credited to his/her telephone or cell phone account, or linked credit account. This would allow a payer to immediately pay a payee by telephone or cell phone, and the payee can get an instant confirmation from his/her phone. In this way, small financial transfers can be made instantaneously without the need for cash. An example of the possibilities is a yard sale or flea market where the seller cannot accept credit cards, but does have a linked credit account. The buyer can simply use a cell phone to transfer the funds and the seller/client would be able to confirm by phone. The same can be done with private automobile sales, where sellers prefer to be paid in cash for fear of being kited. In order to avoid the inherent risks of carrying thousands of dollars, the purchase can be made with a simple phone call, if the seller has a linked credit account.

Similarly, the present disclosure can also be used in conjunction with credit card, debit card, ATM card, or similar systems and payment networks. As an example, the cardholder can have a linked credit account used in conjunction with a credit card, debit card or private card account. This would transform a credit card account into a deposit account capable of accepting deposits anywhere the card is accepted, even worldwide. This use is a great benefit to people that conduct business across state and national borders.

Furthermore, the present disclosure can be used to split payments made by a single payer party among two or more payee parties. As an example, contractors and their supply-chain sub-contractor suppliers can be simultaneously paid by pre-arranged agreement according to each payee's role in the creation of the value of the goods and/or service provider in the business transaction.

An example of an optimum design utilizing the prior art of highly scalable and distributed database architectures is the Internet's Domain Name Service (DNS) and the Internet's public search engines. The present disclosure may utilize a search engine 169 to scan the public DNS (and/or enhanced Private DNS Services) to locate the relevant central directory/processor. The central directory/processor would locate and present the linked credit account information to the payer 170 and ask if he wants to pay. The payer would then receive instructions from the central directory/processor about one or several methods to initiate a credit electronic funds transfer 210 and record a payment pending action in the log file for the LCA 230. The payer can engage his bank payment process immediately 220 or disengage and later send funds (or not) anonymously 180 via the ACH or some other means to the linked credit account at the central directory/processor. Upon receiving the credit electronic funds transfer 220, the central directory/processor would immediately initiate a second internal funds transfer to the payee's regular bank account 240. This function of sweeping the funds from the linked credit account to the payee's regular bank account may have the effect of accelerating the payment to the payee by as much as twenty-four hours compared to using the more common debit electronic funds transfer method of the ACH. Upon receiving positive receipt acknowledgment 260 via various means from the payee's bank 270, the central directory/processor instantly notifies 250 the payer and payee that the transaction has completed successfully. A characteristic of the Internet's DNS infrastructure is the ability to utilize “Anycast technology” from UltraDNS, which simultaneously synchronizes DNS Directory entries for a vast number of URLs of central directory/processors. It is likely that the central directory/processors will be geographically dispersed and associated with payees in various ways. These CD/Ps could be but are not limited to corporate entities (such as Affiliated Network Services, LLC) serving industry sectors in real-time (such as the healthcare industry) and/or individuals (such as healthcare claimants). These CD/Ps may even be located in different parts of the world.

This method may be useful to simultaneously notify in real-time, payers 320 and payees 330 of successful payment initiation and completion steps 280 or unsuccessful payment initiation and completion 300 of transactions across vast distances. The real-time and simultaneous recording and transmission of messages in a log file 310 is an important characteristic of the enhanced design of the present disclosure. For example, when international payments are made to obtain certified and settled ownership of a product or commodity with real-time, certified notification, the product or commodity can be subsequently and/or promptly re-sold to another party anywhere in the world. By recording and informing of the events of transmission of receipt acknowledgement messages 280, 300, the central directory/processor becomes a source of truthful information about every movement of real money into a linked credit account and its real-time disposition into the true owner's account. By simultaneously and in real-time notifying the payer and payee of a payment's final completion and receipt acknowledgment, the opportunity for banking institutions to hold real money (a.k.a. “float”) in the middle of the payment process is reduced. This means that payers can hold on to their money longer and/or payees can receive their money faster.

When funds are transferred between entities in two different countries with dissimilar currencies, currency settlement takes place in the country of destination. This disclosure enables remittance and status information about the trans-national movement of funds through one or several one-way LCA accounts to be trusted and reliably delivered to trading partners and their designated agents in a timely and predictable fashion. Value added services such as new methods for assessing risks for currency exchange rates and new risk abatement techniques can be instituted based on this information capture. This means that the present day costs of sending finds to other countries can be lowered for one or both parties in a transaction.

The aforementioned example illustrates that the present disclosure is a system that is easily integrated into existing systems, thus able to accelerate widespread adoption due to its evolutionary implementation path.

Another advantage of utilizing the public Internet and/or public telephone infrastructure to notify the payer and payee of a successful or unsuccessful transaction completion is to eliminate the unnecessary, costly, and time consuming middle step of the payer's bank or payee's bank relaying such information. Often, this information requires the individual consumer or small business to query either the payer or payee bank or both periodically throughout the week to learn if payment has arrived. Often, automated systems for electronic response such as touch-tone data entry and synthesized speech response methodologies do not accurately reflect the actual payment status. This is especially true whenever such systems generate paper checks (debits) in domestic transactions or in developing countries.

A significantly better alternative, active DNS directories are updated in real-time. A new web page “view” (and its corresponding DNS entry) of a single payment transaction (database listing) in the central directory/processor can be constructed to provide up-to-the-minute “views” of the central directory/processor(s)' payment status information in a log file listing of completed payments 290. This status information (or a subset of it) is deemed to be public information by mutual consent of both payer and payee transaction parties. Status information (or a subset of it) can be observed nearly simultaneously from different parts of the world. In this fashion, the DNS infrastructure of the Internet can be used to accomplish a “poor-man's” electronic clearing network for developing nations, and enable the emergence of computerized trading systems without any more sophistication than simply using the most basic bank EFT functions.

Banks may choose to utilize the FED ACH payment network or EPN network to transmit enrollment data to the central directory. Because the present disclosure can be integrated within the Automated Clearing House of the Federal Reserve Bank of the United States 260 (or equivalent electronic clearing and/or settlement systems such as the Electronic Payment Network, and ATM networks) and/or corresponding institutions in other countries (CHIPS, SWIFT international inter-bank exchange networks), the information reflected in the central directory/processor can always be trusted by banks to be accurate, complete and current.

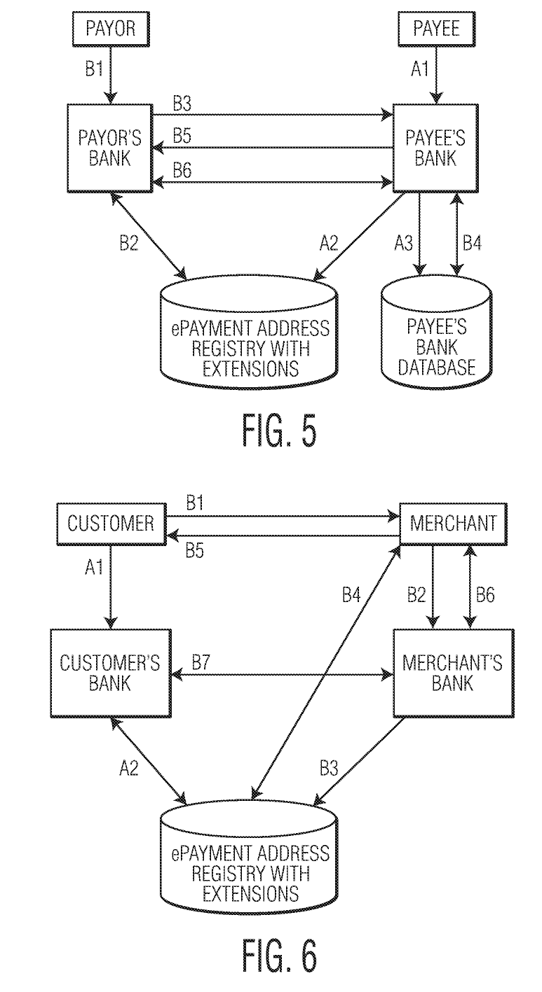

Referring next to FIGS. 5 and 6, additional aspects of the disclosure are described.

In FIG. 5, a payor intends to effect a payment transfer to a payee. The transaction involves currency conversion and notification to the payor of the amount of funds to be paid out upon receipt, net of all fees, in the payee's currency of choice. Prior to the transaction, the payee has entered payment preferences A1 (e.g., that an instant payment at the current currency conversion rate of a specified foreign exchange index is mandatory or that a payment within 12 hours at a currency conversion rate that is most favorable among all possible foreign exchange services available to the payee's bank) into the payee's bank. The payee's bank enters a flag A2 into the extended ePayments address registry that indicates the existence of payment instruction preferences for the payee, and the payee's bank has stored said instructions A3 in its own database. When the payor initiates the payment transaction B1 via the payor's bank, said bank queries the registry B2 for payment information regarding the payee. Upon discovering that payment instruction preferences exist for the payee, the payor's bank queries the payee's bank B3. The payee's bank retrieves and executes the payee's payment instruction preferences B4 from its database. The payor's bank receives the payee's payment instruction preferences B5 from the payee's bank. The payor's bank calculates the net sum to be paid out, notifies the payor, obtains final payment authorization and then initiates and effects the transaction B6 with the payee's bank subject to said payment instruction preferences.

In FIG. 6, a merchant's bank initiates a request for a non-revocable payment from a payor's bank by taking steps to mitigate certain risks of payor repudiation on the grounds that the payment was not authorized by considering additional authentication factors to validate both the customer (i.e., payor) and the customer's device used to make a purchasing transaction. Prior to the purchase, the customer's bank has acquired additional authentication factors A1 from the customer, and in this example the customer's bank has stored those authentication factors A2 in the extended ePayments address registry. When the customer initiates a purchase B1 from a merchant, the merchant's bank initiates a transaction B2 with the payor's bank. The merchant, as a Relying Party, retrieves verification that the Payee's Personal Account Number is registered and authorized for use if and only if additional authentication factors B3 related to the customer from the extended ePayments address registry are retrieved and used to authenticate the payor. The registry communicates authentication instructions B4 with the merchant, and the merchant conducts authentication activity B5 with the customer, so that authentication factors provided by the customer (and/or the customer's device) may be verified with respect to the previously stored authentication factors. Upon successful completion of the authentication steps of the customer and the customer's device used, the merchant's bank submits notification to the payor's bank (or its proxy) that the authentication steps have been completed, and then continues to complete the purchase transaction B6 with the payor's bank. Finally, the payor's bank validates that the authentication instructions were met and effects the payment transaction B7 with the customer's bank.

The present disclosure relates to extending previously established use cases for a network of registries of unique identifiers linked to payment addresses and containing information asset repository addresses, privacy and notification preferences, and other data.

In a preferred embodiment of the present disclosure, a central directory and/or processor (registry) is established and made available to entities wishing to certify the authenticity of instructions to risk bearing institutions and the conditions for when to apply said instructions. The application of said instructions governs various decisions that affect the transfer of monetary and informational assets. The registry marks these instructions as mandatory or optional as deemed by the registrant. The Relying Party that submits queries may be instructed to be redirected to applications residing on other systems whereby the resultant responses deliver certain forms of user authentication data and/or digital credentials or tokens. According to another embodiment, certain Publicly Identifying Information and/or other information attributes can become released only after a Law Enforcement or other legally authorized entity obtains full PII disclosure after legal review by a judge and the issue of subpoena.

In a preferred embodiment, this disclosure facilitates certain transactions such as Cross-border Remittances and Asset Transfer Applications via the use of certain identity attributes and authentication factors, and such information and/or pointers to such information may be stored in the ePayments address registry. Such identity attributes and authentication factors may include but are not limited to the following:
Identity Attributes
   Sender-Receiver Linkage information
   Foreign Exchange Instruction
   Currency Preference (Mandatory/Optional)
   Least Cost Routing
   Hedge
   Timing Preference (Instant/Non-instant)
Authentication Factors
   Secure Element Discovery redirection
   Unique Device Identification (IMEI, Mac Address, UICC, EIN, Secure Element, PKI key, Private Key, Encryption key, token, chip identifier)
   On Screen Display (identifiers, graphics, bar codes, QR codes)
   Communications Methods (Over The Air (OTA) messaging, Cloud Credentials, WiFi, IR, NFC or other wireless methods)
   Cryptographic Elements (Hash, Encryption, Algorithmic, and other Cryptographic techniques)
   Transaction Match

It should be noted that various elements in the above list of authentication factors will apply in other embodiments of the disclosure, and thus in a range of other use cases.

Cross-Border Individual Payer Remittance Payments

Increasingly, regulators require sending institutions to acquire and report such identity attributes to verify that the identities of both parties to a transaction are known prior to moving money across borders. These attributes may include the recipient's name, address, and the account number and financial institution where the money is to be deposited. Generally, eighty-five percent of the cross-border transfers are repetitive transactions between the same two individuals. This linkage is in effect an identity attribute of a sender who habitually sends money to the same receiver and it is also an identity attribute of a receiver who habitually receives money from the same sender. Risk bearing institutions are the entities that initiate the money transfer process. This may occur in two classic ways. First is the case when a receiver's bank “pulls” a debit of a sender's account. For this case, querying a registry to see if the sender's unique identifier is linked to the receiver's unique identifier informs risk scoring and mitigates the risk that a card number might be stolen and used without authorization. In the second case, where a sender's bank “pushes” a credit to a receiver's account, querying a registry to see if the receiver's unique identifier is linked to the sender's unique identifier informs risk scoring and it mitigates the risk that an imposter might be posing as a legitimate accountholder seeking to supply payment instructions that are outside the boundary of normal payment authorization.

Transactions with Intermediate Currencies

One practical use of Bitcoin addressing now is the emerging practice of performing currency exchanges when Bitcoin is used as the intermediate currency in a two-step transaction.

In cases where an anonymous Bitcoin ePayment address is registered in the Greenlist, Anti-Money Laundering (AML) concerns are alleviated because lawful interceptors now have a mechanism to subpoena records of the Identity Provider that functioned as the registrar of the Bitcoin ePayment address. In the future, the banks with customer accounts that are the final recipient account addresses of a multi-step money transfer, and where that transfer involves intermediate currency conversions, can be regulated to only receive money transfers from a intermediate Bitcoin currency account that is registered as paired with a sender's unique identifier, and additionally when that sender's identity is similarly registered as linked to the receiver. In this example, anonymity can be protected for commercial and privacy purposes but in extreme cases where threats to the state or public safety are concerns, a mechanism can exist for lifting the veil of anonymity after proper judicial review and permission is obtained.

Cross-Border Business Payer Remittance Payments

Transactions across borders between businesses in a supply chain may be regular and repetitious, and they may be confined to a few transacting parties; alternatively, transactions may by irregularly timed and the amount of funds in any single transfer may vary widely. Senders may transact with numerous receivers and receivers may transact with multiple senders. When currency conversion is part of the task, the financial institution in the country where funds deposit may; a.) determine the method by which currency value is exchanged or b.) have the payment network or other third party institution perform the currency exchange as a service. As the sums of money transferred and/or the frequency of transfers increase, there is an increased incentive on the part of the recipient to take steps to guarantee that the values of deposits are maximized. It is an attribute of a recipient's identity to require that steps are taken that maximize the value of funds depositing in a recipient's account. This attribute is in the form of a ‘flag’ that when in the on position, requires that the risk-bearing institution that is tasked by the sender to effect a remittance payment should de-couple the foreign exchange function from the money transfer and settlement functions. This information is conveyed during a normal lookup to capture and/or verify a recipient's identifiers to achieve regulatory compliance. In order to comply with the recipient's rules, the sender's Financial Institution must query multiple foreign exchange bid/ask quotations and select the service having the most beneficial rates from the recipient's perspective prior to executing a transaction for currency exchange.

Transactions with Age Verification Requirements

Individuals may wish to purchase an NC-17 theater ticket, a gun, a bottle of wine, adult content, or simply apply a senior citizen discount to purchased items. Verifying that the age of the transacting party is at a minimum 18, 21, 65 or some other age is an identity attribute that is tangential to a payment transaction but still important from pricing and compliance standpoints.

Transactions with Sender and/or Receiver Identification Requirements

The aforementioned gun purchase may require additional identity attributes in addition to verifying that the age of the transaction participant falls within an acceptable range. The aforementioned wine purchase may be subject to a geographic requirement that a gift or purchase not be delivered to a location prohibited by state or local law. Attributes such as health-check, police records-check, etc. may be acquirable by the seller, but such attributes might not be directly available without the transacting party's opportunity to give explicit permission to various identity attribute repositories, identity attribute exchanges, or identity attribute providers. The registry (Greenlist) may include identity attribute referral flags for any number of identity attribute checks including TSA applications, Government discounts, access, etc.

Many more circumstances can be envisioned wherein identification requirements may be involved. For automobiles, VINs, license plate numbers, or E-ZPass® transponder numbers may be required for transactions involving fuel or tolls. For charitable contributions or political donations, certain PII may be record-keeping requirements for such transactions. For example, to comply with possible future FCC regulations, paid political advertising may require the individual identification of the major contributors behind the messages that consume airtime.

Transactions with Mobile Device Authentication

In today's ever changing world, the Internet now follows us wherever we happen to be. Constant digital connectivity and always-on digital devices create numerous opportunities for nefarious criminals to capture, replicate and impose cloned digital credentials to effect an unauthorized (by the true owner) transfer of funds. Additional authentication checks provide the ability to leverage a mobile device itself to further increase the security model. By combining information that may be unique to the device, stored on the device, or accessed from the device along with the PII or Greenlist registry information, the user can be identified at a higher level of security for the processing of a transaction.

Transactions with Mobile Token Authentication

Digital Mobile Tokens can be created for one-time use or multi-use, and can be customized per device and per identity. Tokens can be generated locally on the device or they can be sent directly to a device by the registry. These tokens can be stored on the device itself, or accessed and stored in the cloud. Both hardware and software solutions can be used to create and manage these tokens as required for specific markets and/or applications. Tokens can be stored, maintained and resolved as linked to other unique identifiers by the registry.

Transactions with Biometric Authentication

Biometric solutions can be leveraged for identification and registration into the registry. A variety of solutions is appropriate, including, but not limited to finger print, iris, facial and voice recognition. Biometric profiles can be linked in the registry by pointers and then leveraged to provide additional levels of user identification. This can be supported either directly by mobile devices, or with the addition of accessories to expand the capabilities of the mobile device. The biometric profile information becomes an additional component of the registry data, and can be used to confirm the user at the time of a transaction.

The foregoing descriptions are meant to be illustrative and not limiting. Various changes, modifications, and additions may become apparent to the skilled artisan based upon the disclosure in this specification, and such are meant to be within the scope and spirit of the disclosure as defined by the appended claims.

1. A system for electronic information transfers over a network of payment networks, comprising:
a plurality of electronic servers connected to a communication network, each electronic server comprising a non-transitory memory storing computer-readable instructions that, when executed by a processor, cause the plurality of electronic servers to:
register a unique identifier associated with at least one entity of a first entity and a second entity on a registry, by associating the unique identifier with one or more electronic payment addresses of an account and a holder of said account using at least one directory, said at least one directory functioning as a root directory for real-time synchronizing of content with other directories containing a plurality of unique identifiers associated with a plurality of accounts residing at a plurality of entities, said unique identifier including one or more identity attributes of at least one of the first entity and the second entity;
cause said unique identifier to be registered by a plurality of registrars, each associated with a different payment network in said network of payment networks;
provide said unique identifier to users of an Internet portal or search engine without requiring a password or log-in;
receive transaction information from the first entity via the communication network, the transaction information including the unique identifier associated with said at least one entity, the transaction information indicating a transfer of asset information among the first entity and the second entity, the asset information comprising a decentralized nonmonetary unit of value;
determine whether the unique identifier is linked to at least one of the one or more identity attributes associated with a corresponding entity among the first entity and the second entity by comparing the received unique identifier with at least one of the one or more identity attributes on the registry; and
when the unique identifier is linked to the at least one of the one or more identity attributes, the non-transitory memory further comprises instructions that cause the plurality of electronic servers to:
aggregate the received transaction information from the first entity with previous transaction information,
generate and transmit, over the communication network, a communication based on the aggregated transaction information that includes at least a portion of the transaction information received from the first entity, and
transmit, over the communication network, the generated communication to the second entity connected to the communication network, the second entity configured to receive the communication via the communication network and electronically complete the indicated transfer responsive to the received communication.

2. The system of claim 1, wherein the decentralized nonmonetary unit of value includes a Bitcoin.

3. The system of claim 1, further comprising a third entity connected to the communication network, wherein the third entity is configured to convert the completed transfer of asset information from the decentralized nonmonetary unit of value to a centralized monetary unit of value.

4. The system of claim 1, wherein at least one of the first entity and the second entity comprises a party, a counterparty, a financial institution or an exchange.

5. The system of claim 1, wherein the unique identifier includes at least one of an anonymized or hashed unique identifier.

6. The system of claim 1, wherein the unique identifier is linked to a public encryption key associated with a corresponding entity among the first entity and the second entity.

7. The system of claim 1, wherein the electronic payment address comprises at least one of a masked, hashed or tokenized electronic payment address.

8. The system of claim 1, wherein the electronic payment address includes a Bitcoin address.

9. The system of claim 1, wherein the electronic payment address comprises a publically discoverable electronic payment address.

10. The system of claim 1, wherein the unique identifier is linked to a rule set associated with a corresponding entity among the first entity and the second entity, the rule set including at least one permission for accessing the transaction information within at least one community of interest.

11. The system of claim 10, wherein the rule set includes at least one information containment rule to restrict the transaction information from being transferred beyond the at least one community of interest.

12. The system of claim 1, wherein the transfer of asset information comprises a financial transaction.

13. The system of claim 12, wherein the financial transaction comprises a trade.

14. The system of claim 1, wherein the unique identifier does not reveal an identity of at least one of the first entity and the second entity.

15. The system of claim 1, wherein the non-transitory memory further comprises instructions that cause the plurality of electronic servers to cease the indicated transfer of the asset information when it is determined that the unique identifier is not linked to the at least one of the one or more identity attributes.

16. The system of claim 1, wherein said account is configured to reside at said least one entity and said associated electronic payment addresses of said account is configured to allow withdrawals by said account holder only and to allow a plurality of deposits to be made at different times.

17. The system of claim 1, wherein the directory is in communication with and operable to be queried by a portal system to make deposits directly to the account associated with said unique identifier.

18. The system of claim 1, wherein the directory is in communication with and operable to be queried by a portal system to withdraw funds from a depositor's account and deposit the funds directly into the account associated with said unique identifier.

19. The system of claim 1, wherein said plurality of registrars are configured to aggregate said registrations.

20. The system of claim 1, wherein the non-transitory memory further comprises instructions that cause the plurality of electronic servers to:
receive data over said network of payment networks identifying one or more non-repudiable deposits to be made to said account;
assign said one or more non-repudiable deposits to said account using any one of said payment addresses associated with said unique identifier; and
notify on a real-time basis a depositor of said deposit of said assigning of said one or more non-repudiable deposits to said account.

21. An automated computer-implemented method for electronic information transfers over a network of payment networks via a plurality of electronic servers connected to a communication network, each electronic server comprising a non-transitory memory storing computer-readable instructions executed by a processor, the method comprising:
registering, by the plurality of electronic servers, a unique identifier associated with at least one entity of a first entity and a second entity on a registry, by associating the unique identifier with one or more electronic payment addresses of an account and a holder of said account using at least one directory, said at least one directory functioning as a root directory for real-time synchronizing of content with other directories containing a plurality of unique identifiers associated with a plurality of accounts residing at a plurality of entities, said unique identifier including one or more identity attributes of at least one of the first entity and the second entity;
causing, by the plurality of electronic servers, said unique identifier to be registered by a plurality of registrars, each associated with a different payment network in said network of payment networks;
providing, by the plurality of electronic servers, said unique identifier to users of an Internet portal or search engine without requiring a password or log-in;
receiving, by the plurality of electronic servers, transaction information from the first entity via the communication network, the transaction information including the unique identifier associated with said at least one entity, the transaction information indicating a transfer of asset information among the first entity and the second entity, the asset information comprising a decentralized nonmonetary unit of value;
determining, by the plurality of electronic servers, whether the unique identifier is linked to at least one of the one or more identity attributes associated with a corresponding entity among the first entity and the second entity by comparing the received unique identifier with at least one of the one or more identity attributes on the registry; and
when the unique identifier is linked to the at least one of the one or more identity attributes:
aggregating, by the plurality of electronic servers, the received transaction information from the first entity with previous transaction information,
generating and transmitting, by the plurality of electronic servers, over the communication network, a communication based on the aggregated transaction information that includes at least a portion of the transaction information received from the first entity,
transmitting, by the plurality of electronic servers, over the communication network, the generated communication to the second entity connected to the communication network,
receiving, by the second entity, the communication via the communication network, and
electronically completing, by the second entity, the indicated transfer responsive to the received communication.

22. The method of claim 21, wherein the decentralized nonmonetary unit of value includes a Bitcoin.

23. The method of claim 21, the method further comprising converting, by a third entity connected to the communication network the completed transfer of asset information from the decentralized nonmonetary unit of value to a centralized monetary unit of value.

24. The method of claim 21, wherein at least one of the first entity and the second entity comprises a party, a counterparty, a financial institution or an exchange.

25. The method of claim 21, wherein the unique identifier includes at least one of an anonymized or hashed unique identifier.

26. The method of claim 21, wherein the unique identifier is linked to a public encryption key associated with a corresponding entity among the first entity and the second entity.

27. The method of claim 21, wherein the electronic payment address comprises at least one of a masked, hashed or tokenized electronic payment address.

28. The method of claim 21, wherein the electronic payment address includes at least one of a Bitcoin address or a publically discoverable electronic payment address.

29. The method of claim 21, wherein the unique identifier is linked to a rule set associated with a corresponding entity among the first entity and the second entity, the rule set including at least one permission for accessing the transaction information within at least one community of interest.

30. The method of claim 29, wherein the rule set includes at least one information containment rule to restrict the transaction information from being transferred beyond the at least one community of interest.

31. The method of claim 21, wherein the transfer of asset information comprises a financial transaction.

32. The method of claim 31, wherein the financial transaction comprises a trade.

33. The method of claim 21, wherein the unique identifier does not reveal an identity of at least one of the first entity and the second entity.

34. The method of claim 21, the method further comprising ceasing the indicated transfer of the asset information when it is determined that the unique identifier is not linked to the at least one of the one or more identity attributes.

35. The method of claim 21, wherein said account is configured to reside at said least one entity and said associated electronic payment addresses of said account is configured to allow withdrawals by said account holder only and to allow a plurality of deposits to be made at different times.

36. The method of claim 21, wherein the directory is in communication with and operable to be queried by a portal system to make deposits directly to the account associated with said unique identifier.

37. The method of claim 21, wherein the directory is in communication with and operable to be queried by a portal system to withdraw funds from a depositor's account and deposit the funds directly into the account associated with said unique identifier.

38. The method of claim 21, the method further comprising aggregating, by said plurality of registrars, said registrations.

39. The method of claim 21, the method further comprising:
receiving data over said network of payment networks identifying one or more non-repudiable deposits to be made to said account;
assigning said one or more non-repudiable deposits to said account using any one of said payment addresses associated with said unique identifier; and
notifying on a real-time basis a depositor of said deposit of said assigning of said one or more non-repudiable deposits to said account.
